(19) United States
(12) Patent Application Publication
(10) Pub. No.: US 2005/0195809 A1
(43) Pub. Date: Sep. 8, 2005

(54) SS7 full duplex transverser

(76) Inventor: Farouk M. Zanaty, Palm Bay, FL (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/792,896

(22) Filed: Mar. 5, 2004

(51) Int. Cl. H04L 12/56

(52) U.S. Cl. 370/389

(57) ABSTRACT

A transverser provides a transparent connection between SS7 signaling links and IP systems. The transverser includes at least one of a transmitting module and a receiving module. The transmitting module includes a multiplexer to assemble different messages of received SS7 signal messaging units from different SS7 traffic calls in one stream; a message correlator to rearrange the assembled messages in a message order independent of a time stamp; a payload encoder to encode the rearranged messages into encoded messages having payloads associated with predetermined call identification parameters and indicators; and an encapsulator to encapsulate the encoded messages into encapsulated packets with IP headers to convert, transparently, the received SS7 signal messaging units to a format suitable to transmit over an Internet Protocol (IP) network. The receiving module includes a decapsulator, a payload decoder, and a demultiplexer.

### BACKGROUND OF THE INVENTION

1. Field of the Invention

The present invention relates generally to methods and systems for communicating signaling system 7 (SS7) user messages among SS7 nodes and Internet Protocol (IP nodes). More particularly, the present invention relates to methods and systems for communicating SS7 user messages among SS7 signaling points and IP nodes using modules that process, transmit, and remotely receive SS7 traffic from an SS7 network, wherein traffic is monitored, processed, and analyzed by a signaling processing unit that receives messages from a receiving module of SS7 message signaling units though on an SS7 network.

2. Description of the Related Art

In general, telecommunications networks include a communication pathway for transmission of voice and a separate pathway for transmission of signals that aid in linking a first user with another user to facilitate the voice transmission. Signaling typically takes place transparently, in an out-of band manner, and may include various types of data transmission. That is, the signaling takes place outside the voice band.

SS7 is a global standard for telecommunications defined by the International Telecommunication Union (ITU) Telecommunication Standardization Section (ITU-T). The SS7 standard defines the procedures and protocol used in the public switched telephone network (PSTN) exchange information over a digital signaling network to effect wireless (cellular) and wireline call setup, routing and control. Variations of SS7 may be utilized in different geographical areas.

The SS7 network and protocol are used for basic call setup, management and call tear down. Enhanced call features may be added such as call forwarding, calling party number/number display, and three-way calling.

SS7 messages are typically exchanged between network elements at 56 or 64 kilobit per second bi-direction channels called signaling links. Voice is transmitted in a designated voice band, and signals to control the voice transmission are typically sent on dedicated channels that are out-of-band, i.e., not in a voice band. By using out-of-band signaling, faster call setup times result, when compared with using in-band signaling using multi-frequency signaling tones.

To promote reliable communication, the SS7 digital signaling protocol utilizes an out-of-band common channel signaling system that labels messages to send circuit-related signaling information, non-circuit related signaling information, network resident database service information and other information for establishing a connection.

With respect to hardware, an SS7 network includes a plurality of signaling points (SPs) that are nodes that are interconnected using signaling links. Generally, there are signal transfer points (STPs), service switching points (SSPs), and service control points (SCPs).

SSPs are switches that originate, terminate or place calls in tandem. An SSP sends signaling messages to other SSPs to setup, manage and release voice circuits that are required to make a voice call. Hence, SSPs may handle both in-band signaling links and SS7 signaling. In addition, an SSP may send a query message to a centralized database such as a service control point (an SCP) to determine how to route a call. For example, a query message may be sent to a 1-800 number or a 1-888 number in North America. An SCP sends a response to the originating SSP containing the routing number/numbers associated with the dialed number. Call features may vary in different networks or sets of services. Examples of SSPs include customer switches, a tandem and an access tandem.

An STP routes the network traffic between SPs via a packet switch. The STP routes each incoming message to an outgoing signaling link in accordance with the routing information contained in the SS7 message. Since the STP acts as a network hub, it eliminates a need for direct links between SPs. Generally, an STP may be a packet switch, and STPs may be installed in matched pairs.

SCPs and STPs are generally used in mated pairs in different physical locations to preserve network service in the event of a failure at one particular physical location. Links between SPs are also generally provided in pairs, and traffic may be transmitted across all links of the linkset. Thus, if one link fails, another link in the linkset may be used. SS7 is configured to provide for retransmission and error correction if an SP fails or if a link fails. SCPs control access to a plurality of databases, such as 800 number databases, 800 number carrier identification databases, credit card verification databases and the like.

Signaling datalinks, generally in redundant pairs, connect the SPs and include “A” links that connect SSPs to STPs and that connect SCPs to STPs. Bridge links, typically designated “B” links, connect an STP to another mated STP. “C” (cross) links connect STPs performing identical functions to a mated pair. Generally, a “C” link is used when an STP has no other route available to a destination signaling point due to a link failure or multiple link failures. While STPs may be utilized in pairs to increase reliability, mated SCPs are not interconnected by signaling links. “D” (diagonal) links connect a secondary (e.g., a local or regional) STP to a primary (e.g., an inter-network gateway) STP pair in a quad-link configuration Secondary STPs within a same network are connected via a quad of “D” links. An “E” (extended) link may connect an SSP to an alternate STP. Thus, “E” links provide an alternative signaling path if an SSP's “home” STP cannot be reached via an “A” link. “E” links are not required, but the extra expense for “E” links may be justified by the degree of increased reliability. An “F” (fully associated) link is used to connect two signaling end points, such as SSPs and SCPs. Generally, “F” links are not used in networks with STPs, and in networks without STPs, “F” links connect signaling points directly.

The network protocol for SS7 includes a functional level hierarchy, with levels loosely corresponding to the Open Systems Interconnect (OSI) 7 layer model of the International Standards Organization (ISO). A Message Transfer Part (MTP) is divided into three levels: MTP Level 1 (the lowest level), which is equivalent to the OSI physical layer, and which defines the physical, electrical and functional characteristics of the digital signaling link; MTP Level 2, which ensures accurate end-to-end message transmission across a signaling link so that when an error occurs on a signaling link, the message is retransmitted; and MTP Level 3, which provides message routing between signaling points in the SS7 network such as re-routing traffic away from failed links and signaling points and controlling traffic when congestion occurs. The MTP Level 2 is equivalent to the OSI Data Link Layer, and the MTP Level 3 is equivalent to the OSI Network Layer.

The ISDN User Part (ISUP) defines the protocol used to set-up, manage, and release trunk circuits that carry voice and data between terminating line exchanges. ISUP is used for both ISDN and non-ISDN calls, except that calls that originate and terminate at a same switch do not use ISUP signaling.

In some geographical areas such as China, for example, the Telephone User Part (TUP), which handles only analog circuits, is used to support basic call setup and tear-down. Call management is generally handled by ISUP.

The Signaling Connection Control Part (SCCP) provides services for connectionless and connection-oriented networks above the MTP Level 3. The SCCP translates a global title, which is an address, into a destination point code and a subsystem number. The subsystem number is a unique identifier for an application at a destination signaling point. The SCCP is used as a transport layer for the Transaction Capabilities Applications Part (TCAP), which supports an exchange of non-circuit related data between applications across the SS7 network using the SCCP connectionless service. TCAP messages include queries and responses between SSPs and SCPs. TCAP Mobile Application Part (MAP) messages are sent between mobile switches and databases to support user authentication, equipment identification and roaming.

However, there is a need for a unit that assembles different messages of received SS7 signal messaging units from different SS7 traffic calls in one stream, rearranges the assembled messages in a message order independent of a time stamp, encodes the rearranged messages into encoded messages having payloads associated with predetermined call identification parameters and indicators, and encapsulates the encoded messages into encapsulated packets with IP headers to convert, transparently, the received SS7 signal messaging units to a format suitable to transmit over an Internet Protocol (IP) network.

### SUMMARY OF THE INVENTION

Accordingly, it is an aspect of the present invention to provide a transverser that includes a transmitting module having a multiplexer to assemble different messages of received SS7 signal messaging units from different SS7 traffic calls in one stream; a message correlator to rearrange the assembled messages in a message order independent of a time stamp; a payload encoder to encode the rearranged messages into encoded messages having payloads associated with predetermined call identification parameters and indicators; and an encapsulator to encapsulate the encoded messages into encapsulated packets with IP headers to convert, transparently, the received SS7 signal messaging units to a format suitable to transmit over an Internet Protocol (IP) network; and a receiving module that includes a decapsulator to decapsulate IP headers from messages in SS7 encoded IP packets; a payload decoder to remove payloads of decapsulated SS7 encoded IP packets of different messages having different codes; and a demultiplexer to disassemble removed payloads of different messages into streams to forward over SS7 receiving links, wherein the SS7 encoded IP packets are converted, transparently, to SS7 signal messaging units suitable for transfer over SS7 links.

It is another aspect of the present invention to provide a transmitting transverser module that includes a multiplexer to assemble different messages of received SS7 signal messaging units from different calls in one stream; a message correlator to rearrange the assembled messages in a message order independent of a time stamp; a payload encoder to encode the rearranged messages into encoded messages having payloads associated with predetermined call identification parameters and indicators; and an encapsulator to encapsulate the encoded messages into encapsulated packets with IP headers to convert, transparently, the received SS7 signal messaging units to a format suitable to transmit over an Internet Protocol (IP) network.

In one aspect of the present invention, the transmitting transverser module transmits the encapsulated packets over an IP network or saves the encapsulated packets as a file in a binary format and transfers the encapsulated packets via a file transfer protocol (FTP).

It is another aspect of the present invention that, with respect to the transmitting transverser module, each SS7 signal messaging unit may include an originating point code (OPC), a destination point code (DPC);a circuit identification code (CIC); a signaling link selection (SLS) value; a message type (MT); an integrated services digital network (ISDN) user part; an ISDN access indicator; a holding indicator; and a Signaling Connection Control Part (SCCP) method indicator.

It is another aspect of the present invention that, with respect to the transmitting transverser module, each SS7 signal messaging unit may include an initial address message (IAM); an integrated services digital network user part address complete message (ISUP ACM); an integrated services digital network user part answer message (ISUP ANM); an integrated services digital network user part release message (ISUP REL); and an integrated services digital network user part release complete message (ISUP RELC).

It is another aspect of the present invention that, with respect to the transmitting transverser module, each SS7 signal messaging unit may include the encapsulated packets with IP headers that include IP equivalent streams of packets having header configurations in accordance with at least one of: Asynchronous Transfer Mode (ATM) transmission as cells; Synchronous Optical Network (SONET) transmission as payloads; Digital Subscriber Line (DSL) transmission in accordance with Transmission Control Protocol (TCP)/Internet Protocol (IP); wireless transmission authentication in accordance with a Wired Equivalent Privacy (WEP) standard; wireless transmission authentication in accordance with a Wi-Fi Protected Access standard; and satellite transmission.

It is another aspect of the present invention that the transmitting transverser module may further include firmware to implement processing the SS7 signal messaging units and encapsulating equivalent IP frames or protocol data units.

It is another aspect of the present invention that the transmitting transverser module may further include software residing on a network node to implement processing the SS7 signal messaging units and encapsulating equivalent IP frames or protocol data units.

It is another aspect of the present invention to provide a receiving transverser module that may include a decapsulator to decapsulate IP headers from messages in SS7 encoded IP packets; a payload decoder to remove payloads of decapsulated SS7 encoded IP packets of different messages having different codes; and a demultiplexer to disassemble removed payloads of different messages into streams to forward over SS7 receiving links, wherein the SS7 encoded Internet Protocol (IP) packets are converted, transparently, to SS7 signal messaging units suitable for transfer over SS7 links.

It is another aspect of the present invention that, with respect to the receiving transverser module, each converted SS7 signal messaging unit may include an originating point code (OPC); a destination point code (DPC); a circuit identification code (CIC); a signaling link selection (SLS) value; a message type (MT); an integrated services digital network (ISDN) user part; an ISDN access indicator; a holding indicator; and a Signaling Connection Control Part (SCCP) method indicator.

It is another aspect of the present invention that, with respect to the receiving transverser module, each converted SS7 signaling messaging unit may include an initial address message (IAM); an integrated services digital network user part address complete message (ISUP ACM); an integrated services digital network user part answer message (ISUP ANM); an integrated services digital network user part release message (ISUP REL); and an integrated services digital network user part release complete message (ISUP RELC).

It is another aspect of the present invention that the receiving transverser module may further include firmware to implement processing of the SS7 encoded IP packets to generate SS7 signal messaging units.

It is another aspect of the present invention that the receiving transverser module may further include software residing on a network node to implement processing of the SS7 encoded IP packets to generate SS7 signal messaging units.

It is another aspect of the present invention that, with respect to the transmitting transverser module, functions of the multiplexer, the message correlator, the payload encoder and the encapsulator may be implemented by software modules at a network node computer that converts the SS7 signal message units into the SS7 encoded IP packets. Where desired, the network node computer may be one of: a desktop computer and a laptop computer.

It is another aspect of the present invention that, with respect to the receiving transverser module, functions of the decapsulator, the payload decoder, and the demultiplexer may be implemented by software modules at a network node computer that converts the SS7 encoded IP packets into SS7 signal message units. Where desired, the network node computer may be one of: a desktop computer and a laptop computer.

It is another aspect of the present invention that the transmitting transverser may include an SS7 encoding processor that implements functions of the multiplexer, the message correlator, the payload encoder and the encapsulator, and wherein the SS7 encoding processor receives SS7 signal messaging units and is coupled to a transmitting module to IP unit connector that connects the SS7 encoding processor to an IP unit.

It is another aspect of the present invention that the receiving transverser may include an SS7 decoding processor that is coupled to an IP unit to receiving module connector to receive SS7 encoded IP packets from an IP unit of an IP network, and wherein the SS7 decoding processor implements functions of the decapsulator, the payload decoder, and the demultiplexer to provide SS7 signal messaging units. Where desired, the IP unit may be a satellite.

Additional aspects and advantages of the invention will be set forth in part in the description which follows and, in part, will be obvious from the description, or may be learned by practice of the invention.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a block diagram of one embodiment of an SS7 full duplex transverser having transmitting and receiving modules in accordance with the present invention;

FIG. 2 is a block diagram of an embodiment of an SS7 full duplex transverser having transmitting and receiving modules, together with software drivers, in accordance with the present invention;

FIG. 3 is a block diagram of one embodiment of a transmitting transverser module communicating with a receiving transverser module over a transmitting network in accordance with the present invention;

FIG. 4 is a block diagram of an example of n different messages of n calls being multiplexed into a single stream;

FIG. 5 is a block diagram of one embodiment of a message correlator in accordance with the present invention, wherein the message correlator rearranges messages in call order per a protocol independent of a time stamp;

FIG. 6 is a block diagram of one embodiment of an encoder in accordance with the present invention, wherein the encoder arranges a payload of a message in a predetermined order with respect to call identification parameters and indicators;

FIG. 7 is a block diagram of one embodiment of an encapsulator in accordance with the present invention, wherein the encapsulator encapsulates IP headers and encoded messages to form IP packets;

FIG. 8 is a block diagram of a transmitting transverser module in accordance with one embodiment of the present invention; and

FIG. 9 is a block diagram of a receiving transverser module in accordance with one embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

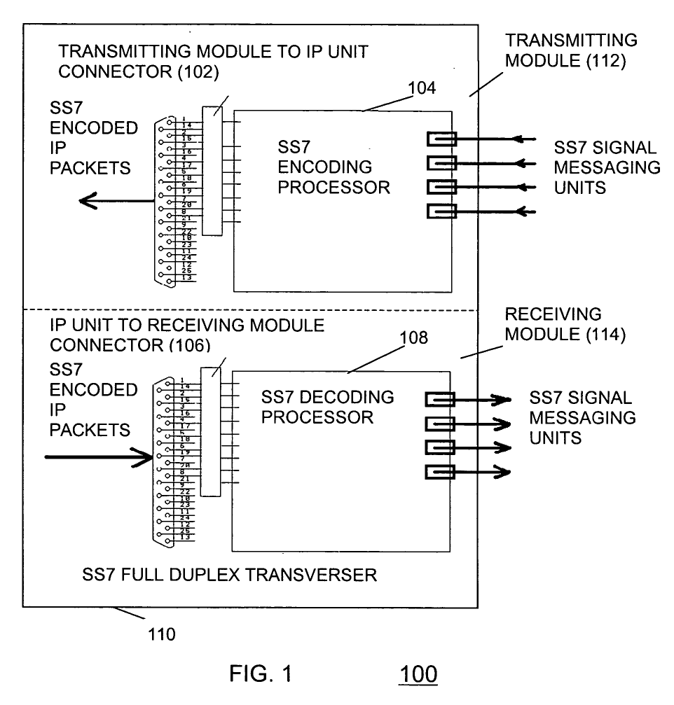

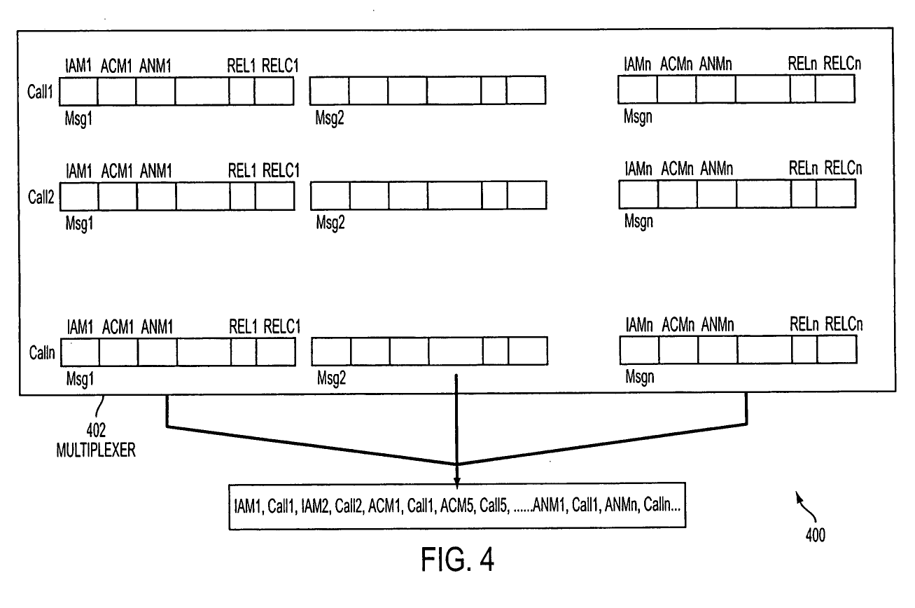

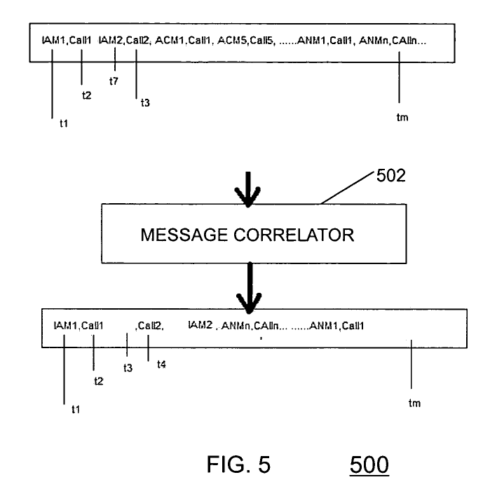

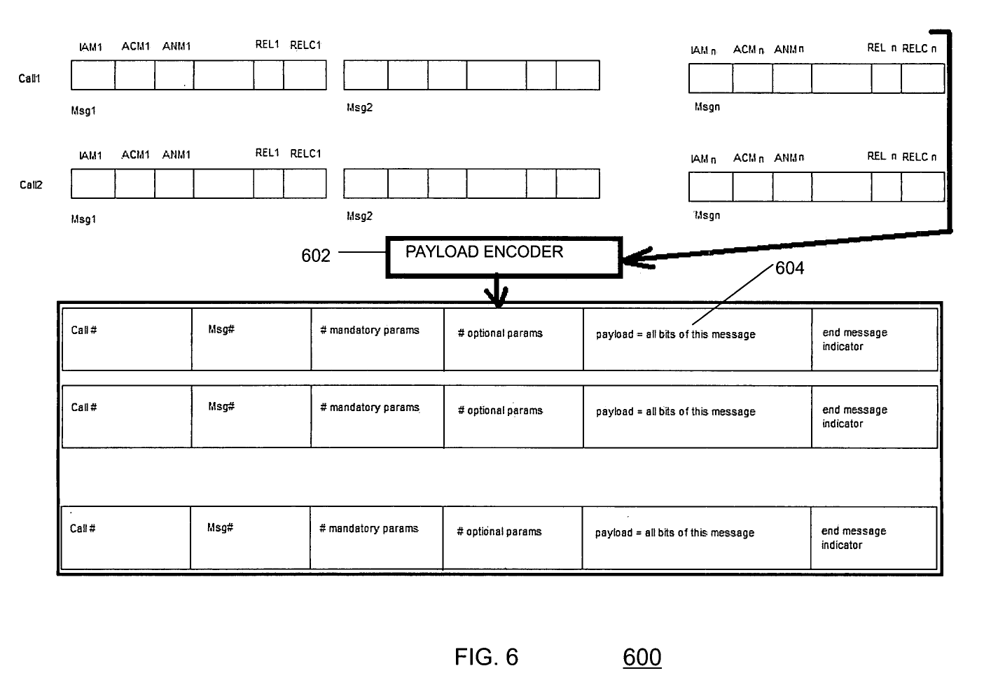

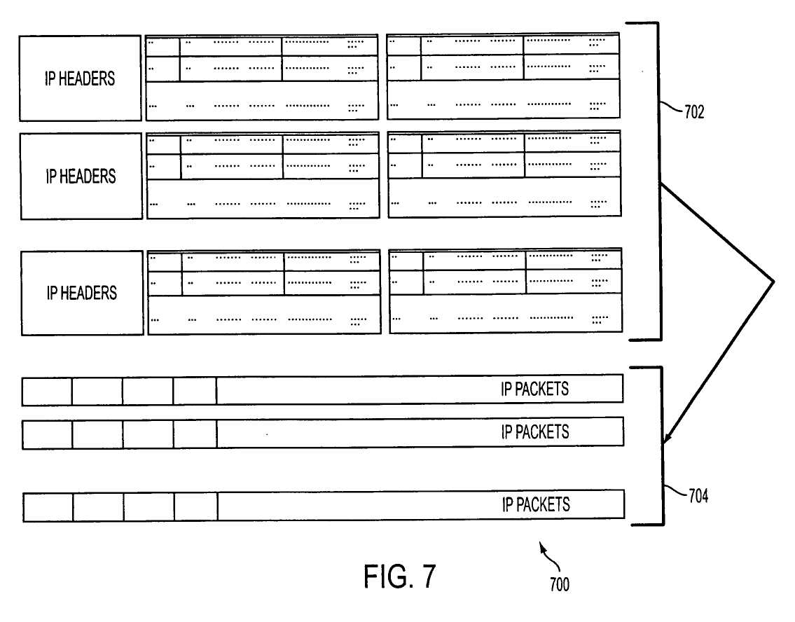

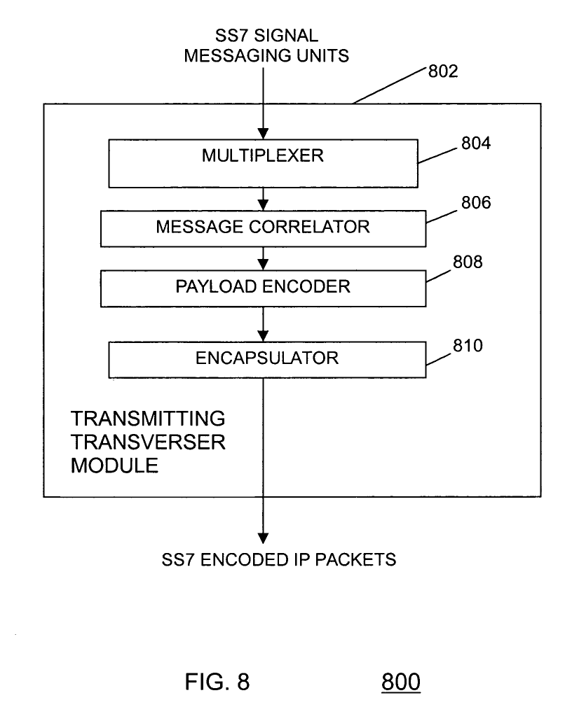

FIG. 1, numeral 100, is a block diagram of one embodiment of an SS7 full duplex transverser 110 having a transmitting module 112 and a receiving module 114 in accordance with the present invention. The transverser 110 typically includes at least one of a transmitting module 112 and a receiving module 114. That is, the transverser 110 may include only one of the transmitting module 112 and the receiving module 114, or may include both. In the embodiment shown in FIG. 1, the SS7 full duplex transverser 110 includes both the transmitting module 112 and the receiving module 114. The transmitting module 112 receives SS7 signal messaging units from an SS7 link. As shown in FIG. 1, numeral 100, and FIG. 8, numeral 800, to implement a transmitting module 112, 802 of the transverser, an SS7 encoding processor 104 may utilize hardware, firmware, software, or a combination thereof to implement functions of a multiplexer 804, a message correlator 806, a payload encoder 808, and an encapsulator 810, as described more fully below. A transmitting module to IP unit connector 102 generally connects the SS7 encoding processor 104 to a desired IP unit. As shown in FIG. 4, numeral 400, a block diagram of an example of n different messages of n calls being multiplexed into a single stream, a multiplexer 402 assembles different messages from different SS7 traffic calls into one stream. Then, as shown in FIG. 5, numeral 500, a message correlator 502 rearranges the assembled messages in order in accordance with the protocol being implemented, independent of the time stamp. Next, as shown in FIG. 6, numeral 600, a payload encoder 602 encodes the rearranged messages into encoded messages having payloads associated with predetermined call identification parameters and indicators. Then, as shown in FIG. 7, numeral 700, an encapsulator 702 encapsulates the encoded messages into encapsulated packets with IP headers 704 to convert, transparently, the received SS7 signal messaging units to a format suitable to transmit over an Internet Protocol (IP) network.

Generally, the encapsulated packets may be transmitted over an IP network or may be saved as a file in a binary format and transferred via a file transfer protocol (FTP).

Each SS7 signal messaging unit typically comprises an originating point code (OPC), a destination point code (DPC), a circuit identification code (CIC), a signaling link selection (SLS) value, a message type (MT), an integrated services digital network (ISDN) user part, an ISDN access indicator, a holding indicator; and a signaling connection control part (SCCP) method indicator. The point codes are numeric addresses that uniquely identify each signaling point in the SS7 network. The destination point code recites a receiving signaling point so that the message may be distributed to a desired user part, such as ISUP or SCCP, that is shown by the service indicator in the Service Information Octet (SIO). If the receiving signaling point has message transfer capabilities, for example, STP, a message to be sent to another signaling point is transferred. The outgoing link to be utilized is determined by the DPC and the SLS.

Since ANSI routing labels use 7 octets and ITU-T routing labels use 4 octets, signaling information exchanged between ANSI and ITU-T networks must be routed through a gateway STP, protocol converter, or other signaling point which has both an ANSI and an ITU-T point code.

In addition, for call set-up, each SS7 signaling messaging unit generally comprises an initial address message (IAM), an integrated services digital network user part address complete message (ISUP ACM), an integrated services digital network user part answer message (ISUP ANM), an integrated services digital network user part release message (ISUP REL), and an integrated services digital network user part release complete message (ISUP RELC).

To facilitate communication, the encapsulated packets with IP headers generally comprise IP equivalent streams of packets having header configurations in accordance with at least one of Asynchronous Transfer Mode (ATM) transmission as cells, Synchronous Optical Network (SONET) transmission as payloads, Digital Subscriber Line (DSL) transmission in accordance with Transmission Control Protocol (TCP)/Internet Protocol (IP), wireless transmission authentication in accordance with a Wired Equivalent Privacy (WEP) standard, wireless transmission authentication in accordance with a Wi-Fi Protected Access standard, and satellite transmission.

Where desired, firmware may be utilized to implement processing the SS7 signal messaging units and encapsulating equivalent IP frames or protocol data units.

Also, where desired, software residing on a network node, such as a desktop computer, a laptop computer or the like, may be used to implement processing the SS7 signal messaging units and encapsulating equivalent IP frames or protocol data units.

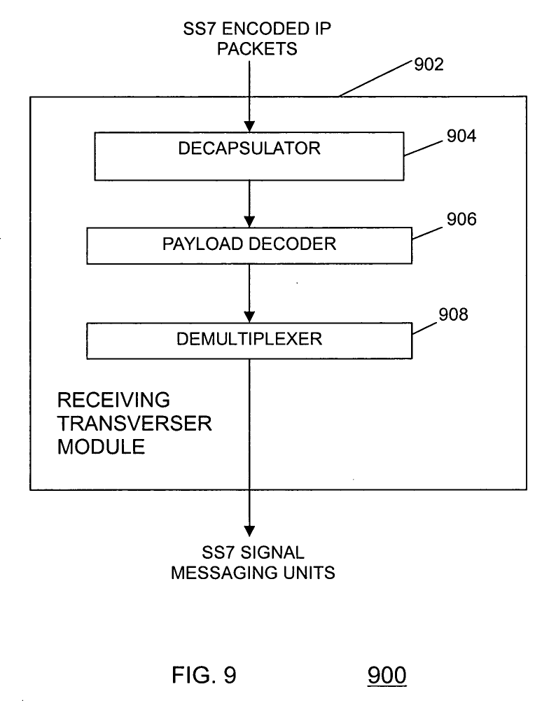

The receiving module 114, 902 of the transverser 110 performs substantially in reverse fashion as compared with the transmitting module 112, 802, except that no reverse version of the message correlator 502, 806 is required. As shown in FIG. 1, numeral 100, and FIG. 9, numeral 900, a receiving module 114, 902 may utilize an SS7 decoding processor 108 to implement functions of a decapsulator 904 that decapsulates IP headers from messages in SS7 encoded IP packets; a payload decoder 906 to remove payloads of decapsulated SS7 encoded IP packets of different messages having different codes; and a demultiplexer 908 to disassemble removed payloads of different messages into streams to forward over SS7 receiving links, wherein the SS7 encoded IP packets are converted, transparently, to SS7 signal messaging units suitable for transfer over SS7 links. Thus, the SS7 signal messaging units may then be fed, for example, into a standard Line Interface Module. The SS7 decoding processor 108 may be implemented in hardware, firmware, software or a combination thereof. An IP unit to receiving module connector 106 generally connects the SS7 decoding processor 108 to a desired SS7 link.

Typically, each converted SS7 signal messaging unit comprises an originating point code (OPC), a destination point code (DPC), a circuit identification code (CIC), a signaling link selection (SLS) value, a message type (MT), an integrated services digital network (ISDN) user part, an ISDN access indicator, a holding indicator, and a Signaling Connection Control Part (SCCP) method indicator.

To facilitate coordination of messages, each converted SS7 signaling messaging unit generally comprises an initial address message (IAM), an integrated services digital network user part address complete message (ISUP ACM), an integrated services digital network user part answer message (ISUP ANM), an integrated services digital network user part release message (ISUP REL), and an integrated services digital network user part release complete message (ISUP RELC).

Where desired, the receiving transverser module 902 may comprise firmware to implement processing of the SS7 encoded IP packets to generate SS7 signal messaging units.

In one embodiment, the receiving transverser module 902 may include software residing on a network node, such as, for example, a desktop computer or a laptop computer, to implement processing of the SS7 encoded IP packets to generate SS7 signal messaging units.

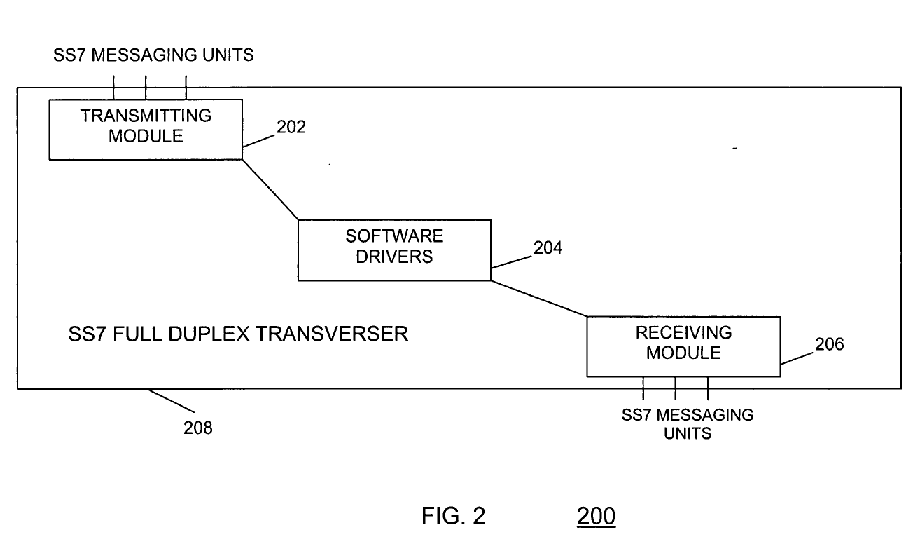

Software drivers may replace or complement the on-board functional software modules that convert the SS7 signal messaging unit information to SS7 encoded IP packets. The drivers may include multiplexer/demultiplexer, message correlator, payload encoder/decoder and encapsulator/decapsulator functions that allow both transmitting and receiving modules to operate in a real-time environment. For example, in one embodiment of the SS7 full duplex transverser 208, as shown in FIG. 2, the multiplexer/message correlator/payload encoder/encapsulator of the transmitting module 202 may reside in a built-in chip on a circuit board. Software drivers 204 may be utilized by the transmitting module 202 and/or the receiving module 206.

FIG. 8 also shows how the transmitting transverser module 802 operates. The multiplexer 804 samples the signaling units at rates defined by the T1 or E1 rates for North American and European markets, respectively. The message correlator 806 places the samples in sequential order for each call. The payload encoder 808 assembles each 8 bits into ASCII octets (bytes) and arranges the octets in concatenated fashion into sequential streams of bytes, together with predetermined call identification parameters and indicators. Then, the encapsulator 810 encapsulates the concatenated bytes with IP headers to convert, transparently, SS7 signal messaging units received from an SS7 link, to a format suitable to transmit over an Internet Protocol (IP) network.

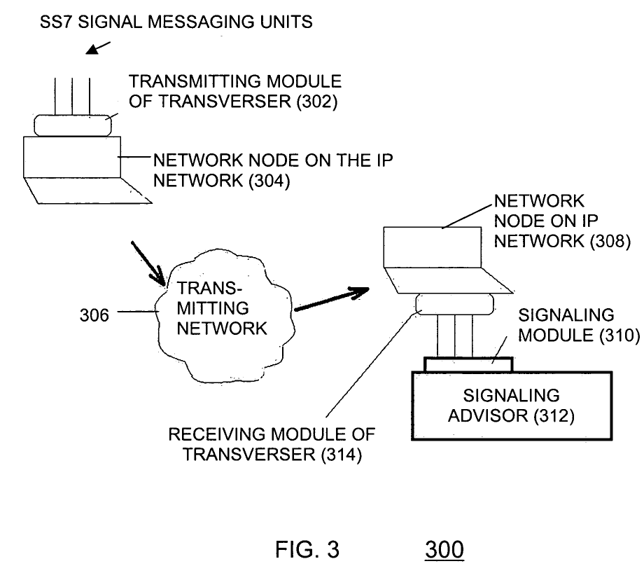

As shown in FIG. 3, numeral 300, a block diagram of one embodiment of a transmitting transverser module 302 communicating with a receiving transverser module 314 over a transmitting network 306 in accordance with the present invention, SS7 signal messaging units may be converted at a network node on an IP network 304, transmitted on an IP network to another network node 308, and, where desired, may be sent to a signaling module 310 and then sent to a SIGNALING ADVISOR® by AGILENT®, wherein the SIGNALING ADVISOR® may be used for protocol analysis and to generate graphical statistics and graphical call tracing.

The SS7 full duplex transverser is portable in functionality and operates on any network element that is connected to a local, wide, metropolitan, wired or wireless area network. The two modules for transmitting and receiving with supporting software drivers provide an SS7 full duplex transverser that is physically packageable and portable. By utilizing separate transmitting and receiving modules, such modules may readily be exchanged to accommodate different communication ports.

The SS7 full duplex transverser may support North American, European and other SS7 signaling units in present use, as well as protocol stack levels Message Transfer Part 2 (MTP2), Message Transfer Part 3 (MTP3), services including Simple Network Management (SNM), Mobile Telephone Networks (MTN), SCCP, and ISUP, and users such as IS41 and SCCP Management (SCMG). Protocol stacks such as frame relay, General Packet Radio Service (GPRS), ISDN and Transcoder Radio Adapter Unit (TRAU) may be supported by the transverser, as well as protocols such as ANSI ISUP, ANSI MTN, ANSI SCCP, ANSI SNM, BELLCORE® ISUP, BELLCORE® SCCP, BELLCORE® Sequence Number (SN) and ITU MTN.

Various protocols and standards are discussed herein. However, the present invention is not limited to any particular protocol or standard.

Although a few embodiments of the present invention have been shown and described, it would be appreciated by those skilled in the art that changes may be made in these embodiments without departing from the principles and spirit of the invention, the scope of which is defined in the claims and their equivalents.

1. A transverser comprising:
a transmitting module comprising:
a multiplexer to assemble different messages of received SS7 signal messaging units from different SS7 traffic calls in one stream;
a message correlator to rearrange the assembled messages in a message order independent of a time stamp;
a payload encoder to encode the rearranged messages into encoded messages having payloads associated with predetermined call identification parameters and indicators; and
an encapsulator to encapsulate the encoded messages into encapsulated packets with IP headers to convert, transparently, the received SS7 signal messaging units to a format suitable to transmit over an Internet Protocol (IP) network; and
a receiving module comprising:
a decapsulator to decapsulate IP headers from messages in SS7 encoded IP packets;
a payload decoder to remove payloads of the decapsulated SS7 encoded IP packets of different messages having different codes; and
a demultiplexer to disassemble removed payloads of different messages into streams to forward over SS7 receiving links,
wherein the SS7 encoded IP packets are converted, transparently, to SS7 signal messaging units suitable for transfer over SS7 links.

2. A transmitting transverser module comprising:
a multiplexer to assemble different messages of received SS7 signal messaging units from different calls in one stream;
a message correlator to rearrange the assembled messages in a message order independent of a time stamp;
a payload encoder to encode the rearranged messages into encoded messages having payloads associated with predetermined call identification parameters and indicators; and
an encapsulator to encapsulate the encoded messages into encapsulated packets with IP headers to convert, transparently, the received SS7 signal messaging units to a format suitable to transmit over an Internet Protocol (IP) network.

3. The transmitting transverser module of claim 2, wherein one of:
the encapsulated packets are transmitted over an IP network; and
the encapsulated packets are saved as a file in a binary format and transferred via a file transfer protocol (FTP).

4. The transmitting transverser module of claim 2, wherein each SS7 signal messaging unit comprises:
an originating point code (OPC);
a destination point code (DPC);
a circuit identification code (CIC);
a signaling link selection (SLS) value;
a message type (MT);
an integrated services digital network (ISDN) user part;
an ISDN access indicator;
a holding indicator; and
a Signaling Connection Control Part (SCCP) method indicator.

5. The transmitting transverser module of claim 2, wherein each SS7 signaling messaging unit comprises:
an initial address message (IAM);
an integrated services digital network user part address complete message (ISUP ACM);
an integrated services digital network user part answer message (ISUP ANM);
an integrated services digital network user part release message (ISUP REL); and
an integrated services digital network user part release complete message (ISUP RELC).

6. The transmitting transverser module of claim 2, wherein the encapsulated packets with IP headers comprise IP equivalent streams of packets having header configurations in accordance with at least one of:
Asynchronous Transfer Mode (ATM) transmission as cells;
Synchronous Optical Network (SONET) transmission as payloads;
Digital Subscriber Line (DSL) transmission in accordance with Transmission Control Protocol (TCP)/Internet Protocol (IP);
wireless transmission authentication in accordance with a Wired Equivalent Privacy (WEP) standard;
wireless transmission authentication in accordance with a Wi-Fi Protected Access standard; and
satellite transmission.

7. The transmitting transverser module of claim 2, further comprising firmware to implement processing the SS7 signal messaging units and encapsulating equivalent IP frames or protocol data units.

8. The transmitting transverser module of claim 2, further comprising software residing on a network node to implement processing the SS7 signal messaging units and encapsulating equivalent IP frames or protocol data units.

9. A receiving transverser module comprising:
a decapsulator to decapsulate IP headers from messages in SS7 encoded IP packets;
a payload decoder to remove payloads of the decapsulated SS7 encoded IP packets of different messages having different codes; and
a demultiplexer to disassemble removed payloads of different messages into streams to forward over SS7 receiving links,
wherein the SS7 encoded Internet Protocol (IP) packets are converted, transparently, to SS7 signal messaging units suitable for transfer over SS7 links.

10. The receiving transverser module of claim 9, wherein each converted SS7 signal messaging unit comprises:
an originating point code (OPC);
a destination point code (DPC);
a circuit identification code (CIC);
a signaling link selection (SLS) value;
a message type (MT);
an integrated services digital network (ISDN) user part;
an ISDN access indicator;
a holding indicator; and
a Signaling Connection Control Part (SCCP) method indicator.

11. The receiving transverser module of claim 9, wherein each converted SS7 signaling messaging unit comprises:
an initial address message (IAM);
an integrated services digital network user part address complete message (ISUP ACM);
an integrated services digital network user part answer message (ISUP ANM);
an integrated services digital network user part release message (ISUP REL); and
an integrated services digital network user part release complete message (ISUP RELC).

12. The receiving transverser module of claim 9, further comprising firmware to implement processing of the SS7 encoded IP packets to generate SS7 signal messaging units.

13. The receiving transverser module of claim 9, further comprising software residing on a network node to implement processing of the SS7 encoded IP packets to generate SS7 signal messaging units.

14. The transmitting transverser module of claim 2, wherein functions of the multiplexer, the message correlator, the payload encoder and the encapsulator are implemented by software modules at a network node computer that converts the SS7 signal message units into the SS7 encoded IP packets.

15. The transmitting transverser module of claim 14, wherein the network node computer is one of: a desktop computer and a laptop computer.

16. The receiving transverser module of claim 9, wherein functions of the decapsulator, the payload decoder, and the demultiplexer are implemented by software modules at a network node computer that converts the SS7 encoded IP packets into SS7 signal message units.

17. The receiving transverser module of claim 16, wherein the network node computer is one of: a desktop computer and a laptop computer.

18. The transmitting transverser module of claim 2, wherein the transmitting transverser comprises an SS7 encoding processor that implements functions of the multiplexer, the message correlator, the payload encoder and the encapsulator, and wherein the SS7 encoding processor receives SS7 signal messaging units and is coupled to a transmitting module to IP unit connector that connects the SS7 encoding processor to an IP unit.

19. The receiving transverser module of claim 9, wherein the receiving transverser comprises an SS7 decoding processor that is coupled to an IP unit to receiving module connector to receive SS7 encoded IP packets from an IP unit of an IP network, and wherein the SS7 decoding processor implements functions of the decapsulator, the payload decoder, and the demultiplexer to provide SS7 signal messaging units.

20. The receiving transverser module of claim 19, wherein the IP unit is a satellite.
